(19) United States
(12) Patent Application Publication
(10) Pub. No.: US 2010/0118469 A1
(43) Pub. Date: May 13, 2010

(54) ELECTROLYTE SOLUTION FOR ELECTRIC DOUBLE LAYER CAPACITOR

(75) Inventors: Hiroaki Shima, Tokushima (JP); Shoji Hiketa, Tokushima (JP); Yoshinobu Abe, Tokushima (JP); Akihiro Nabeshima, Tokushima (JP); Taiji Nakagawa, Tokushima (JP); Masatoshi Uetani, Tokushima (JP)

Correspondence Address: WENDEROTH, LIND & PONACK, L.L.P., 1030 15th Street, N.W.,, Suite 400 East, Washington, DC, 20005-1503, US

(73) Assignee: Otsuka Chemical Co., Ltd.

(21) Appl. No.: 12/450,465

(22) PCT Filed: Mar. 26, 2008
(86) PCT No.: PCT/JP2008/056508

§ 371 Date: Jan. 6, 2010

(51) Int. Cl. H01G 9/038

(52) U.S. Cl. 361/502; 252/62.2

(57) ABSTRACT

An electrolyte solution for electric double layer capacitors, which comprises the following (a) and (b):
(a) a compound represented by the formula (1),
(b) a mixed solvent comprising ethylmethyl carbonate, at least one kind selected from chain carbonates other than ethylmethyl carbonate, and at least one kind selected from cyclic carbonates,

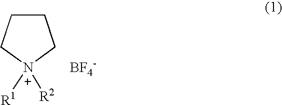

(wherein R¹ and R² may be the same or different and independently denote methyl, ethyl, methoxymethyl or ethoxymethyl, or may form a ring structure).

### TECHNICAL FIELD

The present invention relates to electrolyte solutions for electric double layer capacitors.

### BACKGROUND ART

As electrolyte solutions for electric double layer capacitors, nonaqueous electrolyte solutions, in which a solid-state electrolyte is dissolved in a solvent, are known. The electric conductivity of an electrolyte solution changes with the concentration of the electrolyte. As the electrolyte concentration increases, the ion concentration of the electrolyte solution increases and eventually reaches a maximum point. Then the electric conductivity begins to decrease. The reason for this is considered as follows: With the increase of the number of ions in the electrolyte solution, the electrolyte becomes less dissociable due to increased solvent-ion and ion-ion interaction, and simultaneously, the viscosity of the electrolyte solution increases. After the concentration of the electrolyte further increases and reaches saturation, no further dissociation occurs. Thus, there has been a problem that in a higher concentration solution of the electrolyte, the electrolyte is hard to be dissolved. In addition, when an electrolyte solution containing high level of electrolyte dissolved therein is used in a low-temperature environment, a problem of salt deposition occurs, causing decrease of electric conductivity of the electrolyte solution as well.

As a means to solve such problems, mixing various kinds of organic solvents to obtain electrolyte solutions with high electric conductivity is disclosed (for example, U.S. Pat. No. 3,440,607 and U.S. Pat. No. 3,156,546).

U.S. Pat. No. 3,440,607 discloses that an electrolyte solution for an electric double layer capacitor which uses an electric double layer formed at an interface between a polarizable electrode and the electrolyte solution, obtained by dissolving triethylmethylammonium salt as a solute in a mixed solvent of a chain carbonate and ethylene carbonate, has improved ion mobility and high electric conductivity and can be used without much reduction of ionic dissociation degree of the triethylmethylammonium salt.

U.S. Pat. No. 3,156,546 discloses that an electrolyte solution for an electric double layer capacitor which uses an electric double layer formed at an interface between a polarizable electrode and the electrolyte solution, obtained by dissolving triethylmethylammonium salt as a solute in a nonaqueous solvent comprising (a) 10 to 80% by weight of dimethyl carbonate and (b) 90 to 20% by weight of propylene carbonate, has improved ion mobility and high electric conductivity and can be used without much reduction of ionic dissociation degree of the triethylmethylammonium salt.

Also, JP-2006-351915A discloses an electrolyte solution for electric double layer capacitors, the electrolyte solution comprising a spiro quaternary ammonium tetrafluoroborate such as spiro-(1,1′)-bipyrrolidinium tetrafluoroborate as an electrolyte in a mixed solvent of dimethyl carbonate, ethylene carbonate and propylene carbonate, and having low viscosity, excellent properties at low-temperature (that is, even in a low temperature range, the electrolyte solution does not solidify, and has high relative permittivity and high electric conductivity), and excellent long-term reliability, and an electric double layer capacitor produced by using the electrolyte solution.

WO2005/003108 discloses that an electrolyte solution having high electric conductivity and high voltage resistance can be obtained by using, as an electrolyte, a quaternary ammonium salt having a pyrrolidine skeleton and an N,O-acetal skeleton structure in the molecule.

However, these known electrolyte solutions have high electric conductivity in ordinary temperature (25° C.) but do not have sufficiently high electric conductivity at low temperature at not higher than −30° C. Therefore, an electrolyte solution for electric double layer capacitors, having high electric conductivity at such low temperature is desired.

An object of the present invention is to provide an electrolyte solution for electric double layer capacitors, the electrolyte solution having low viscosity and high electric conductivity even at low temperature from −30 to −40° C., and to provide an electric double layer capacitor using the electrolyte solution.

### DISCLOSURE OF THE INVENTION

The present invention relates to the following inventions.
1. An electrolyte solution for electric double layer capacitors, which comprises the following (a) and (b):
   (a) a compound represented by the formula (1),
   (b) a mixed solvent comprising ethylmethyl carbonate, at least one kind selected from-chain carbonates other than ethylmethyl carbonate, and at least one kind selected from cyclic carbonates,

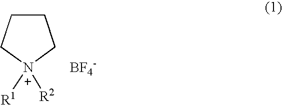

(wherein R¹ and R² may be the same or different and independently denote methyl, ethyl, methoxymethyl or ethoxymethyl, or may form a ring structure).
2. The electrolyte solution for electric double layer capacitors according to the above 1, wherein the chain carbonate is dimethyl carbonate.
3. The electrolyte solution for electric double layer capacitors according to the above 1, wherein the cyclic carbonate is ethylene carbonate.
4. The electrolyte solution for electric double layer capacitors according to the above 1, wherein the chain carbonate is dimethyl carbonate and the cyclic carbonate is ethylene carbonate.
5. The electrolyte solution for electric double layer capacitors according to any one of the above 1 to 4, wherein the compound represented by the formula (1) is liquid at 25° C.
6. An electric double layer capacitor using the electrolyte solution for electric double layer capacitors according to any one of the above 1 to 5.

The electrolyte solution of the present invention for electric double layer capacitors is an electrolyte solution for electric double layer capacitors which comprises (a) and (b).

(a) a compound represented by the formula (1),

(b) a mixed solvent comprising ethylmethyl carbonate, at least one kind selected from chain carbonates, and at least one kind selected from cyclic carbonates,

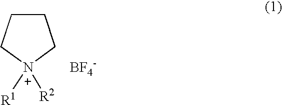

(wherein R¹ and R² may be the same or different and independently denote methyl, ethyl, methoxymethyl or ethoxymethyl, or may form a ring structure).

Examples of R¹ and R² of the compound represented by the formula (1) include methyl, ethyl, methoxymethyl and ethoxymethyl. Examples of the ring structure formed by R¹ and R² include pyrrolidine ring, etc.

The specific examples include compounds such as, N-ethyl-N-methyl pyrrolidinium tetrafluoroborate, N,N-diethyl pyrrolidinium tetrafluoroborate, N-methyl-N-methoxymethyl pyrrolidinium tetrafluoroborate, N-ethyl-N-methoxymethyl pyrrolidinium tetrafluoroborate, N-methyl-N-ethoxymethyl pyrrolidinium tetrafluoroborate, N-ethyl-N-ethoxymethyl pyrrolidinium tetrafluoroborate, Spiro-(1,1′)-bipyrrolidinium tetrafluoroborate, etc. Compounds that are liquid at 25° C. are N-methyl-N-methoxymethyl pyrrolidinium tetrafluoroborate, N-methyl-N-ethoxymethyl pyrrolidinium tetrafluoroborate, and N-ethyl-N-ethoxymethyl pyrrolidinium tetrafluoroborate.

Examples of the chain carbonate used in the present invention include dimethyl carbonate, methyl n-propyl carbonate, methylisopropyl carbonate, n-butyl methyl carbonate, diethyl carbonate, ethyl n-propyl carbonate, ethylisopropyl carbonate, fluorodimethyl carbonate, difluoro dimethyl carbonate, trifluoro dimethyl carbonate, tetrafluoro dimethyl carbonate, fluorodimethyl carbonate, fluoroethylmethyl carbonate, difluoro ethylmethyl carbonate, trifluoroethyl methyl carbonate, methyl acetate, ethyl acetate, methyl propionate, methyl fluoroacetate, methyl difluoroacetate, methyl trifluoroacetate, ethyl fluoroacetate, ethyl difluoroacetate, ethyl trifluoroacetate, methyl fluoropropionate, methyl difluoropropionate, methyl trifluoropropionate, etc.

Dimethyl carbonate is preferred. Examples of the cyclic carbonate used in the present invention include ethylene carbonate, propylene carbonate, butylene carbonate, 4-fluoro-1,3-dioxolan-2-one, 4-(trifluoromethyl)-1,3-dioxolan-2-one, etc.

Ethylene carbonate and propylene carbonate are preferred.

The mixed solvent used in the present invention is preferably a three-in-one mixed solvent comprising ethylmethyl carbonate, dimethyl carbonate and ethylene carbonate. In the electrolyte solution of the present invention, the content of the compound represented by the formula (1) is preferably 10 to 60% by weight, more preferably 15 to 40% by weight, and still more preferably 20 to 35% by weight.

In the electrolyte solution of the present invention, the content of the three-in-one mixed solvent is preferably 40 to 90% by weight, more preferably 60 to 85% by weight, and still more preferably 65 to 80% by weight.

In the three-in-one mixed solvent, the content of ethylmethyl carbonate is preferably 5 to 60% by weight, more preferably 8 to 40% by weight, and still more preferably 10 to 30% by weight.

In the three-in-one mixed solvent, the content of the chain carbonate is preferably 20 to 80% by weight, more preferably 30 to 70% by weight, and still more preferably 40 to 60% by weight.

In the three-in-one mixed solvent, the content of the cyclic carbonate is preferably 10 to 80% by weight, more preferably 20 to 70% by weight, and still more preferably 25 to 60% by weight.

The method for preparing the electrolyte solution of the present invention will be described below. The work environment is not particularly limited as long as it is free from the ingress of atmospheric air, which contains moisture that adversely affects the performance of electric double layer capacitors. However, the preparation is preferably performed in a glove box having an inert gas atmosphere such as argon, nitrogen or the like. The moisture content of the work environment can be monitored using a dew-point meter; preferred temperature of the work environment is −60° C. or lower. If −60° C. is exceeded, the electrolyte solution absorbs moisture from the atmosphere and the moisture content of the solution increases in the case of prolonged working. The moisture content of an electrolyte solution can be measured with a Karl Fischer moisture titrator.

The electrolyte solution of the present invention for electric double layer capacitors can have low viscosity and improved electric conductivity even at low temperature from −30 to −40° C. As a result, an electric double layer capacitor using the electrolyte solution of the present invention for electric double layer capacitors can have low internal resistance and improved capacitance even at low temperature from −30 to −40° C.

Using the above-obtained electrolyte solution of the present invention, an electric double layer capacitor can suitably be fabricated. Examples of the electric double layer capacitor include a laminated type capacitor. However, the shape of the electric double layer capacitor is not limited to the laminated type, and may be a stacked type comprising stacked electrodes accommodated in a can, a rolled type comprising rolled up electrodes accommodated in a can, or a coin type comprising a metal can electrically insulated with an insulating gasket. Hereafter, the structure of a laminated type electric double layer capacitor will be described as an example.

FIG. 1 and FIG. 2 show a laminated type electric double layer capacitor. Electrodes 3, bonded to aluminum tabs 1, are arranged opposite to each other with a separator 4 disposed therebetween, and are accommodated in a laminate 2. Each electrode comprises a polarizable electrode portion made of a carbon material such as activated carbon, and a current collector portion. The laminated container 2 is hermetically sealed by thermocompression bonding to prevent ingression of moisture and air from outside the container.

The polarizable electrode material preferably has high specific surface area and high electric conductivity. Also, the material needs to be electrochemically stable against the electrolyte solution within the range of the voltage to be applied. Examples of such a material include a carbon material, a metal oxide material, a conductive polymer material, etc. In view of the cost, the polarizable electrode material is preferably a carbon material.

The carbon material is preferably an activated carbon material. The specific examples include sawdust activated carbon, coconut shell activated carbon, pitch coke activated carbon, phenolic resin activated carbon, polyacrylonitrile activated carbon, cellulosic activated carbon, etc.

Examples of the metal oxide material include ruthenium oxide, manganese oxide, cobalt oxide, etc. Examples of the conductive polymer material include a polyaniline film, a polypyrrole film, a polythiophene film, a poly(3,4-ethylenedioxythiophene) film, etc.

The electrode can be obtained by press molding of the above-mentioned polarizable electrode material and a binder or by mixing the polarizable electrode material, a binder and an organic solvent such as pyrrolidine to obtain a paste, coating a current collector such as an aluminum foil with the paste, and then drying the paste.

The separator preferably has high electron insulating properties, high wettability with the electrolyte solution, and high ion permeability, and needs to be electrochemically stable within the range of the voltage to be applied. Although the material of the separator is not particularly limited, preferred are paper made from rayon, Manila hemp or the like; porous polyolefin film; nonwoven polyethylene fabric; nonwoven polypropylene fabric; etc.

### BRIEF DESCRIPTION OF DRAWINGS

FIG. 1 is a front view showing a laminated type electric double layer capacitor of the present invention.

FIG. 2 is a diagram showing the internal configuration of a laminated type electric double layer capacitor of the present invention.

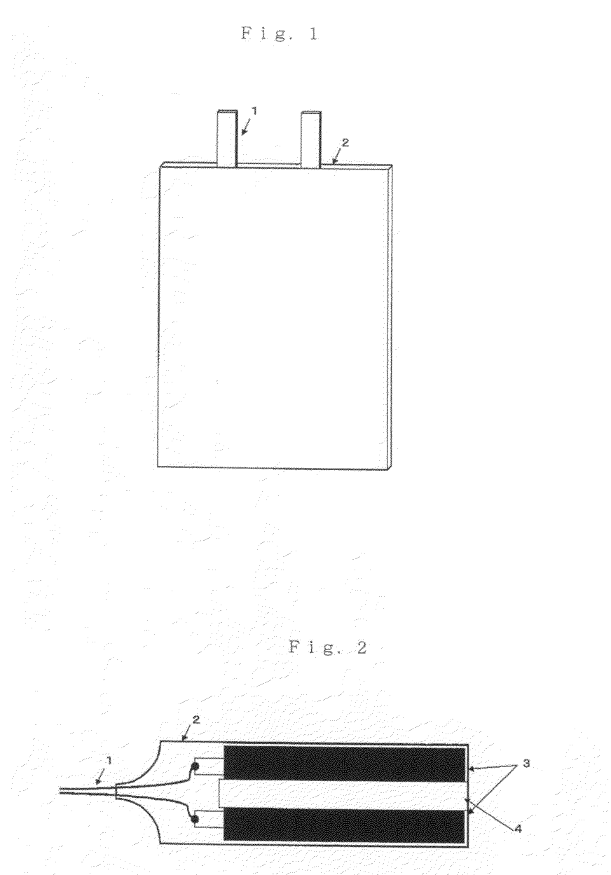

1 Aluminum Tab, 2 Laminate, 3 Electrode, 4 Separator

### DESCRIPTION OF PREFERRED EMBODIMENTS

Hereinafter, the present invention will be described in more detail by reference to Reference Examples, Examples, and Test Examples, but the present invention is not limited thereto.

Hereinafter, the present invention will be described in more detail based on Examples, but the present invention is not limited thereto. Ethylmethyl carbonate (EMC), ethylene carbonate (EC), dimethyl carbonate (DMC), and propylene carbonate (PC) used in the following Examples were of lithium battery grade, made by Kishida Chemical Co., Ltd.

### (Preparation of Electrodes)

To prepare polarizable electrodes, activated carbon powder 80% by weight, acetylene black 10% by weight, and polytetrafluoroethylene powder 10% by weight were kneaded with a roller and rolled through rolls into a 0.1 mm thick sheet. A 0.03 mm etched aluminum foil was joined thereto with a conductive paste such as a carbon paste to form an electrode sheet. This sheet was punched with a die, and laminated type electrodes were obtained.

### (Preparation of Electric Double Layer Capacitors)

Using the laminated type electrodes, a cellulosic separator, and a previously prepared electrolyte solution, prepared was a laminated type electric double layer capacitor with rated voltage of 2.5V and capacitance of 18F.

### (Evaluation Method)

In a thermostat bath set at 25° C. or −30° C., constant voltage charge at 2.5 V for 24 hours and subsequent discharge to 0.0 V were performed for aging treatment. Then, the capacitor was allowed to stand at a predetermined temperature for several hours, and constant voltage charge at 2.5V was again performed for 30 minutes, followed by discharge at 2.0 mA/cm² to a predetermined voltage. From the voltage gradient, the capacitance and internal resistance were determined.

The electric conductivity was measured using an electric conductivity meter made by Radiometer Analytical. CDC641T made by Radiometer Analytical was used as a measuring cell. To determine the electric conductivity of each electrolyte solution, a container having the measuring cell and the electrolyte solution therein was placed in water at 25° C. or a refrigerant at −30° C. After the reading was stabilized, the value was determined as the measured value. VISCOMATE VM-16-L made by CBC Materials was used for viscosity measurement. To determine the viscosity of each electrolyte solution, a container having the measuring cell and the electrolyte solution therein was placed in water at 25° C. or a refrigerant at −30° C. After the reading was stabilized, the value divided by the density of the electrolyte solution was determined as the measured value.

### Example 1

Blended were 24 parts by weight of Spiro-(1,1′)-bipyrrolidinium tetrafluoroborate (SBP-BF₄) (made by Otsuka Chemical Co., Ltd.), 24 parts by weight of ethylene carbonate (EC), 23 parts by weight of ethylmethyl carbonate (EMC), and 29 parts by weight of dimethyl carbonate (DMC) so that an electrolyte solution was obtained.

Blending was performed in a dry box having nitrogen atmosphere, in which the dew point was not higher than −60° C. The moisture content of the solution was measured with a Karl Fischer moisture titrator (a trace moisture titrator AQ-7 made by Hiranuma Sangyo Co., Ltd.) and was confirmed to be not more than 30 ppm.

The electrolyte solution was measured for electric conductivity and viscosity, and the above-mentioned electric double layer capacitor using the electrolyte solution was measured for capacitance and resistance. The results are shown in Table 1.

### Example 2

Blended in the same manner as in Example 1 were 25 parts by weight of N-methoxymethyl-N-methyl pyrrolidinium tetrafluoroborate (MMMP-BF₄) (made by Otsuka Chemical Co., Ltd.), 25 parts by weight of ethylene carbonate (EC), 25 parts by weight of ethylmethyl carbonate (EMC), and 25 parts by weight of dimethyl carbonate (DMC) so that an electrolyte solution was obtained.

The electrolyte solution was measured for electric conductivity and viscosity, and the above-mentioned electric double layer capacitor using the electrolyte solution was measured for capacitance and resistance. The results are shown in Table 1.

### Example 3

Blended in the same manner as in Example 1 were 25 parts by weight of N-methoxymethyl-N-methyl pyrrolidinium tetrafluoroborate (same as above), 30 parts by weight of ethylene carbonate (EC), 25 parts by weight of ethylmethyl carbonate (EMC), and 20 parts by weight of dimethyl carbonate (DMC) so that an electrolyte solution was obtained.

The electrolyte solution was measured for electric conductivity and viscosity, and the above-mentioned electric double layer capacitor using the electrolyte solution was measured for capacitance and resistance. The results are shown in Table 1.

### Example 4

Blended in the same manner as in Example 1 were 24 parts by weight N-methoxymethyl-N-methyl pyrrolidinium tetrafluoroborate (same as above), 24 parts by weight of ethylene carbonate (EC), 23 parts by weight of ethylmethyl carbonate (EMC), and 29 parts by weight of dimethyl carbonate (DMC) so that an electrolyte solution was obtained.

The electrolyte solution was measured for electric conductivity and viscosity, and the above-mentioned electric double layer capacitor using the electrolyte solution was measured for capacitance and resistance. The results are shown in Table 1.

### Example 5

Blended were 30 parts by weight of N-methoxymethyl-N-methyl pyrrolidinium tetrafluoroborate (same as above), 30 parts by weight of ethylene carbonate (EC) (same as above), 15 parts by weight of ethylmethyl carbonate (EMC) (same as above), and 25 parts by weight of dimethyl carbonate (DMC) (same as above) so that an electrolyte solution was obtained.

The electrolyte solution was measured for electric conductivity and viscosity, and the above-mentioned electric double layer capacitor using the electrolyte solution was measured for capacitance and resistance. The results are shown in Table 1.

### Comparative Example 1

Blended in the same manner as in Example 1 were 24 parts by weight of Spiro-(1,1′)-bipyrrolidinium tetrafluoroborate (same as above), 24 parts by weight of ethylene carbonate (EC), 29 parts by weight of propylene carbonate (PC), and 23 parts by weight of dimethyl carbonate (DMC) so that an electrolyte solution was obtained.

The electrolyte solution was measured for electric conductivity and viscosity, and the above-mentioned electric double layer capacitor using the electrolyte solution was measured for capacitance and resistance. The results are shown in Table 1.

### Comparative Example 2

Blended in the same manner as in Example 1 were 25 parts by weight of N-methoxymethyl-N-methyl pyrrolidinium tetrafluoroborate (same as above), 25 parts by weight of ethylene carbonate (EC), 25 parts by weight of propylene carbonate (PC), and 25 parts by weight of dimethyl carbonate (DMC) so that an electrolyte solution was obtained.

The electrolyte solution was measured for electric conductivity and viscosity, and the above-mentioned electric double layer capacitor using the electrolyte solution was measured for capacitance and resistance. The results are shown in Table 1.

TABLE 1

| | Electric | | Viscosity | | | | |
|---|---|---|---|---|---|---|---|
| | conductivity (mS/cm) | | (mPa · s) | Capacitance | | Resistance | |
| | 25° C. | −30° C. | −30° C. | 25° C. | −30° C. | 25° C. | −30° C. |
| Ex. 1 | 17.7 | 5.6 | 5.7 | 17.14 | 15.20 | 0.081 | 0.26 |
| Ex. 2 | 17.0 | 4.8 | 5.8 | 17.40 | 15.77 | 0.071 | 0.30 |
| Ex. 3 | 18.1 | 4.9 | 7.1 | 17.36 | 15.50 | 0.076 | 0.24 |
| Ex. 4 | 16.7 | 4.8 | 5.5 | 17.55 | 16.28 | 0.080 | 0.28 |
| Ex. 5 | 20.8 | 5.2 | 6.8 | 17.63 | 13.01 | 0.061 | 0.33 |
| Com. Ex. 1 | 20.5 | 4.9 | 12.5 | 17.20 | 14.64 | 0.082 | 0.40 |
| Com. Ex. 2 | 20.1 | 4.6 | 11.8 | 17.32 | 14.68 | 0.079 | 0.39 |

### INDUSTRIAL APPLICABILITY

The electrolyte solution of the present invention for electric double layer capacitors can have low viscosity and improved electric conductivity even at low temperature from −30 to −40° C. As a result, an electric double layer capacitor using the electrolyte solution of the present invention for electric double layer capacitors can have low internal resistance and improved capacitance even at low temperature from −30 to −40° C.

1. An electrolyte solution for electric double layer capacitors, which comprises the following (a) and (b):
(a) a compound represented by the formula (1),
(b) a mixed solvent comprising ethylmethyl carbonate, at least one kind selected from chain carbonates other than ethylmethyl carbonate, and at least one kind selected from cyclic carbonates, 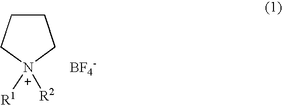
(wherein R¹ and R² may be the same or different and independently denote methyl, ethyl, methoxymethyl or ethoxymethyl, or may form a ring structure).

2. The electrolyte solution for electric double layer capacitors according to claim 1, wherein the chain carbonate is dimethyl carbonate.

3. The electrolyte solution for electric double layer capacitors according to claim 1, wherein the cyclic carbonate is ethylene carbonate.

4. The electrolyte solution for electric double layer capacitors according to claim 1, wherein the chain carbonate is dimethyl carbonate and the cyclic carbonate is ethylene carbonate.

5. The electrolyte solution for electric double layer capacitors according to any one of claims 1 to 4, wherein the compound represented by the formula (1) is liquid at 25° C.

6. An electric double layer capacitor using the electrolyte solution for electric double layer capacitors according to any one of claims 1 to 4.

7. An electric double layer capacitor using the electrolyte solution for electric double layer capacitors according to claim 5.
